(19) United States
(12) Patent Application Publication
(10) Pub. No.: US 2012/0213903 A1
(43) Pub. Date: Aug. 23, 2012

(54) Apparatus for modified heated air flow to floor holder

(76) Inventor: Alfred R. Wagner, Hayden Lake, ID (US)

(21) Appl. No.: 12/932,214

(22) Filed: Feb. 22, 2011

(51) Int. Cl. A23L 1/48

(52) U.S. Cl. 426/520; 99/483

(57) ABSTRACT

A food warming and cooking apparatus used over a burner of a range or similar heat source. The apparatus has a base section adapted to cover the heater and help contain heated air therein. A heat modifier having a plurality of emitters emits heated air into an intermediate section. A pot or other food holder is placed into a receiver during operation. One or more guides position the pot for even cooking. Hot air is emitted in a manner that induces good heat transfer at relatively lower temperatures than would be experienced by direct contact of a pot or other cooking implement to reduce the risk of sticking and scorching.

### BACKGROUND

Heating and warming devices are well-known in the art of foodstuffs. Some foodstuffs are particularly difficult to heat without the cook watching and stirring to maintain the contents at even temperatures to avoid sticking, scorching, boiling over, and similar problems or inconveniences. This is particularly illustrated by sauces and gravy-type contents. It is also desirable to heat such contents without making a mess upon adjacent countertops and floors by avoiding bubbling and spattering.

Many prior devices suffer from the inability to eliminate overheating. Another problem suffered by most devices for heating contents susceptible to sticking are hot spots on the bottom of the pots or other containers or at other locations thereon. Overheating and uneven heating may cause foodstuffs being heated to stick, scorch or burn on the inside of the pot or container.

Until now, efforts to avoid the above-mentioned problems and control heat have involved what are commonly called “slow cookers”. These slow cookers keep the temperature of the inside cooking vessel relatively low and even. In many cases heavy ceramic cooking vessels have been used to keep temperatures on the inside surface even and at the desired relatively low temperature levels. The heat flux is consistently low, distributing heat to the foodstuff heating container and to the contents in a manner which requires long periods of time, such as at least several hours and more commonly during the course of a working day.

The prior art also includes relatively complex heating devices, many having various controls for temperature, time or other operational parameters. These devices, in addition to the prior mentioned failings, often suffer from their complexity. Such features have caused users to misuse the devices or suffer difficulties. Such misuse and difficulties may be due to impatience causing overheating, prematurely turning the device off, and forgetting to turn the device on or off. Inconsistent results thus commonly occur due to the uneven heating caused by prior heating apparatuses for foodstuffs and the like which cannot be heated under high heat flux.

Thus, there has been a long-felt need for a cooking apparatus which can without watching, stirring and other monitoring, heat food in a manner which avoids or minimizes sticking, scorching, burning, and preferably without spattering of the contents.

It is believed that to date all prior devices suffer significantly from one or more of these problems, or others. The current inventions seek to successfully address this long-felt need without suffering from or by minimizing such problems, constraints and difficulties.

### BRIEF DESCRIPTION OF THE DRAWINGS

Preferred forms, configurations, embodiments and/or diagrams relating to and helping to describe preferred aspects and versions of the inventions are explained and characterized herein, often with reference to the accompanying drawings. The drawings and all features shown therein also serve as part of the disclosure of the inventions of the current document, whether described in text or merely by graphical disclosure alone. Such drawings are briefly described below.

FIG. 1 is an exploded perspective view of a preferred apparatus according to the inventions.

FIG. 2 is a top view of an intermediate part or assembly 200.

FIG. 3 is a side view of the intermediate part 200 of FIG. 2.

FIG. 4 is a bottom view of the intermediate part 200 of FIG. 2.

FIG. 5 is a top view of the base part 100 of FIG. 1.

FIG. 6 is an exploded front view of the base part 100 of FIG. 5 positioned over an electric range unit.

FIG. 7 is a top view of a preferred mounting and assembly piece used in the intermediate assembly of FIGS. 1-4.

FIG. 8 is a side view of a preferred mounting piece used in the assembly of FIG. 7.

FIG. 9 is a front view of a preferred mounting piece used in the assembly of FIG. 7.

### DETAILED DESCRIPTION

A table of sections of this detailed description follows.

TABLE OF DETAILED DESCRIPTION SUBSECTIONS

| | |
|---|---|
| INTRODUCTORY NOTES | Generally |
| A PREFERRED ASSEMBLY | Heat Source and Surround |
| BASE UNIT | Base Heat Containment |
| | Predominant Heat Containment |
| | Features and Aspects |
| | Heat Modifier |
| | Heat Controller |
| | Base Handling Features |
| | Base Features for Positioning of |
| | Intermediate Section |
| | Additional Surface Features and |
| | Aspects of the Heat Controller |
| | Top Wall |
| | Standoffs or Spacers |
| HEAT CONTROLLER AND | Preferred Heat Emitters |
| MODIFIER | |
| INTERMEDIATE SECTION | Generally |
| OR COLLAR | Heat Transfer |
| | Receiver |
| | Lower Portion of Intermediate Section |
| | Engagement of Intermediate Section |
| | with Base |
| | Transition Section |
| | Intermediate Section Top Opening & |
| | Rim |
| | Pot Positioners |
| | Clips for Positioners and Engagement |
| FOOD HOLDER OR POT | Food Holder or Vessel |
| | Handle |
| | Optional Lid or Cover |
| TOP VENT OR VENTS | |
| ASSEMBLY MODES | |
| MANNERS AND METHODS | |
| OF USE | |
| MANNER OF MAKING | |
| INTERPRETATION NOTES | |

### DETAILED DESCRIPTION OF THE INVENTIONS

### Introductory Notes

The readers of this document should understand that the embodiments described herein may rely on terminology used in any section of this document and other terms readily apparent from the drawings and the language common therefor as may be known in a particular art and such as known or indicated and provided by dictionaries. Dictionaries were used in the preparation of this document. Widely known and used in the preparation hereof are Webster's Third New International Dictionary (© 1993), The Oxford English Dictionary (Second Edition, ©1989), and The New Century Dictionary (©2001-2005), all of which are hereby incorporated by reference for interpretation of terms used herein and for application and use of words defined in such references to more adequately or aptly describe various features, aspects and concepts shown or otherwise described herein using more appropriate words having meanings applicable to such features, aspects and concepts.

This document is premised upon using one or more terms with one embodiment that may also apply to other embodiments for similar structures, functions, features and aspects of the inventions. Wording used in the claims is also descriptive of the inventions, and the text and meaning of the claims and abstract are hereby incorporated by reference into the description in their entirety as originally filed. Terminology used with one, some or all embodiments may be used for describing and defining the technology and exclusive rights associated herewith.

The readers of this document should further understand that the embodiments described herein may rely on terminology and features used in any suitable section or other embodiments shown in this document and other terms readily apparent from the drawings and language common or proper therefor. This document is premised upon using one or more terms or features shown in one embodiment that may also apply to or be combined with features and aspects of other embodiments for and provide additional embodiments of the inventions.

### A Preferred Assembly

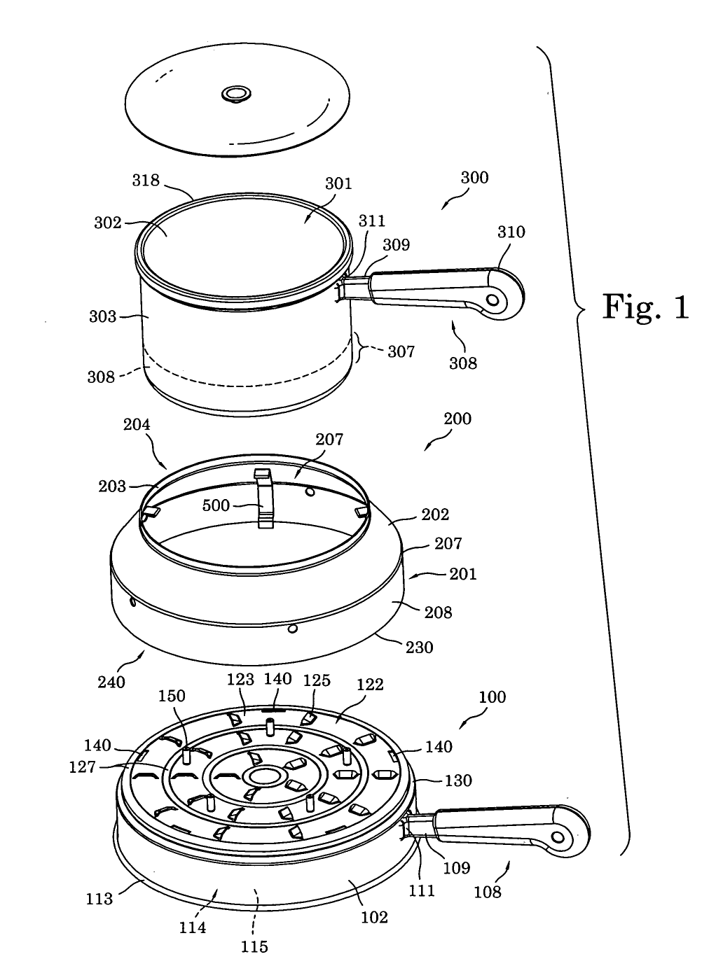

FIG. 1 shows a preferred assembly according to which various inventions hereto have been illustrated for ease of understanding. A brief review of FIG. 1, indicates that there is a base unit 100, intermediate assembly or collar 200 and a food holder 300. The parts assemble with the base 100 positioned over a heat source, the intermediate assembly 200 positioned on the base, and a food holder 300 positioned above the base and with portions within the intermediate assembly 200. Food is gently cooked in the food holder using this novel arrangement. Some assemblies according to the inventions may include or not include the pot or food holder 300. A lid 400 may be included to cover the top opening of the pot.

### Base Unit

FIGS. 1, 5 and 6 show one preferred construction for base unit 100. The preferred base 100 has a sidewalls or, as shown, sidewall 102. The lower edge of the sidewall 102 preferably has a rim 113 which increases the strength of the lower edge and provides greater durability. Within rim 113 is a bottom opening 114 (FIG. 1) which is defined by rim 113 or other suitable structures upon the lower side of the base 100.

The preferred construction for base 100 also advantageously includes an integrated top wall 122. Side wall 102 and top wall 122 are preferably joined to better serve in performing as heat containment walls to contain or capture heat provided by a heat source 50 (see FIG. 6) over which the base is placed.

### Heat Source and Surround

In general, burners and heating units used on typical cooking ranges and other appliances of this type have some ventilation which occurs from the area open beneath the burner or heating element. As shown in FIG. 6, this is provided on an electrical range in part as a bottom opening or intake port 51. Port 51, as shown, is formed in a heat reflector and drip collector 52 which are typically one or more inserts into the range top opening 57.

These range inserts 52 are typically provided in the form of concave or recessed dish-shaped units which fit between a bezel ring 54 and the range top 56. The range top or other adjacent area forms a surround which is typically outside of the bezel ring 54 of an electrical heating element 50 or a gas burner (not illustrated) in some designs. The surround is preferably relatively flat so that rim 113 may lay upon the surround surface formed by range top 56.

The specifics of the heater designs vary but air flow is desired to provide an intake via a suitable cold air intake port, such as heater port 51. This port 51 supplies air to the area about the heating element or other heat source. The heated air is then partially contained and stored within the interior chamber 115 (see FIG. 1) of the reservoir of hot or heated air contained by the sidewall 102 and top wall 122.

Whichever source of heat is used for the burner or other heater or heat source the base still performs beneficial effects in helping to contain heated air and provides for heat capacitance in the heat containment chamber, such as surrounded by the outer wall 102 and the preferred top wall 122. It is preferred that at least some cool air intake or ventilation be provided so that air flow from the enclosed heat containment chamber is able to both enter the interior chamber and be emitted or otherwise discharged as is further detailed herein.

### Base Heat Containment

As shown, base unit 100 has several functions. In one aspect the base acts as a heat container for containing heat provided from a suitable heat source, such as an electrical heater, such as a range or other electrical cooking appliance. In such an aspect or aspects the base unit acts as a heat container and functions to surround a burner or other heating unit or source upon which the base is being used. Exemplary heating units include such heat sources as a range top heating element, gas fuel burner, and other suitable heat sources available for cooking upon. It further acts to contain heat by forming a desirably close fit with the range top or other heater surround 56 (FIG. 6) which may be the flat area about an electrical resistance heating element, or about a gas burner, both as are typically used in cooking appliances commonly present in homes and businesses.

### Predominant Heat Containment Features and Aspects

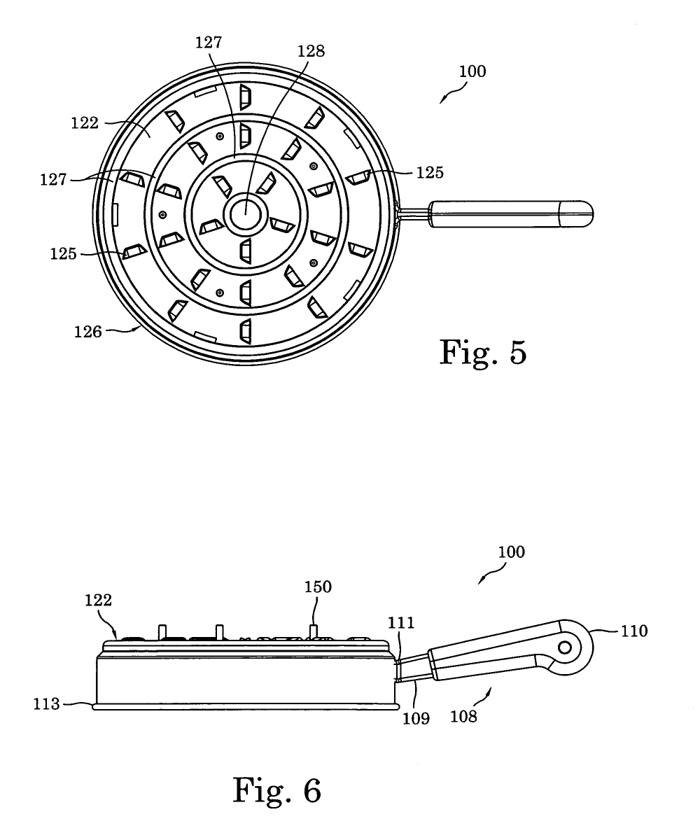

FIGS. 5 and 6 shows a base unit having a novel construction according to the inventions. As shown, the base 100 is preferably built in a form that includes a perimeter or outer wall 102 to help contain heat therein. This preferred and illustrated construction also may include a top part 122 which forms another heat containment wall which in this preferred construction is integral with the outer wall 102. It may alternatively be suitable to have these detachable and still have an operable apparatus, but an integrated structure is currently preferred.

### Heat Modifier

In another aspect the base 100 is adapted to act as a heat modifier. This is in the preferred construction done by converting the relative balance of the different types of heat transfer modes used to transfer heat to a cooking pot or other food holder. For example, a typical pot or pan receives heat by several different modes. One typical mode is direct conduction from a heating element to the bottom of a pot or pan. Another typical mode of heat transfer is by convection with hot air around the heating element heating the bottom and sides of a food container.

Another typical heat transfer mode, radiant heat, is transferred to a cooking pot or pan by beaming the radiant heat. This is exemplified by a glowing orange heating element that beams radiant heat not only to the pot or pan surface which is typically immediately adjacent thereto but also to any surface upon which the radiant heat waves may strike or otherwise impinge. Similarly, a gas flame produces radiant heat as well as conductive and convective heating. The particular heater being used may have different relative balances of different modes of heat transfer, such as the balances of convective, conductive and radiant heat transfer modes.

The preferred novel apparatuses according to the inventions hereof appear to act not only to modify these modes and possibly others, but also tends to change the balance of heating modes between different types of heat sources into a type of heating which is predominantly convective in the preferred modes shown. Other embodiments according to the inventions hereof may be constructed in such a manner as to change the relative balance between the modes and have different degrees of control upon the amount of total heat being imposed upon the cooking vessel.

The heat modifiers according to this invention modify these and possibly other modes of heat transfer by reducing conductive heating and radiant heating and modifying them to provide a greater degree of convective air heating. Further the nature of each or some of these modes of heat transfer may be modified in the degree and way in which that mode of heat transfer occurs. For example, the base as shown changes convective heating by changing the amount of heated air impinging upon the pan or pot and the direction in which the heated air is directed, the velocity of the heated air and the angle of impingement of the heated air.

### Heat Controller

In another aspect the preferred base 100 effects a heat controlling function by limiting the amount of radiant heat, conductive heat and convective heating. The controlling function will vary dependent upon the construction to provide a heat modifier and controller which controls, modifies and moderates heat transfer in a currently preferred apparatus according to the invention. The heat modifier preferably may perform in several different capacities and manners. In another desired capacity it shields and controls the food contents unit from heat transfer modes including direct radiant heating, direct convective heat exposure, and by preventing direct conductive heating, and in other heat modifying ways that will be further indicated herein.

### Base Handling Features

Heat controller 100 also advantageously has a handle 108 which includes a shaft 109 and a grip 110. The shaft is connected in various suitable ways, such as by weldment 111, fastening with fasteners or rivets (not shown), or other suitable connection which is advantageously a strong and heat resistant connection. The shaft is as shown welded to the outer wall of the heat controller. Mechanical connections without fasteners may also be used.

### Base Features for Positioning of Intermediate Section

The base is also adapted to receive the intermediate section 200 using a ledge 130 which preferably mates with a complementary sized lower edge 230 on the intermediate section 200. Other features may also be provided to facilitate assembly and maintain proximity between the base and intermediate parts of the apparatus. Exemplary added features are explained in greater detail below.

### Additional Surface Features and Aspects of the Heat Controller Top Wall

The top wall 122 also is advantageously provided with an upper surface 123 which as shown has a generally planar shape except for the louvers 125 and the circumferential dividers 127 advantageously arranged between radially spaced rows of louvers 125. The dividers 127 extend in a suitable shape depending upon the shape of the perimeter of the heat controller or as is otherwise suitable. As shown, the heat controller is in a generally cylindrical or other annular shape. The outer or circumferential edge of top wall 122 is near the top outer portion of the top wall of the heat controller 100. The inner or circumferential divider encloses a center section 128 (FIG. 5). As shown, there are four annular strips 127 with three radial zones in which louvers 125 are arranged.

### Standoffs or Spacers

The apparatus also advantageously includes at least one standoff which, as shown, is implemented in the form of a plurality of standoff pillars 150 (FIGS. 1, 5 and 6). These standoffs may provide support of the lower surfaces 307 of the food holder 300, specifically at the bottom 308 of the food holder and serve to determine the lowest position possible.

The intermediate assembly 200 has positioning pieces 500 which may adjust lateral position, or alternatively both vertical and lateral depending upon the size of the food holder being used. In preferred use at this time, the food holder rests on the standoff spacers and is laterally positioned or both by the positioning pieces 500.

### Heat Controller and Modifier

As illustrated and easily seen in FIG. 1, the preferred base unit has a top wall 122. Top wall 122 may include heat emissive openings 125 and other features of significance in modifying and controlling heat transfer to the food holding and cooking unit 300. This also works with the intermediate section 200 to perform the desired heat modifying and controlling effects.

Top wall 122 also may include features of utility to other structural and functional attributes included in or on the top wall and the related operational effects. These possible and preferred added features will be detailed after first considering the heat emitters 125.

The heat emissive openings or emitters 125 are shown most clearly in FIGS. 1 and 5. Emitters 125 are preferably configured to provide movement of relatively hot air from within the heat capacitive interior chamber 115 of the base. Heat is provided by a burner, heating element or other heater (not shown) over which the base is placed, for example an electric heating element or gas burner of a cooking range.

Within the heat container formed by base 100 hot air is at least partly contained to form a supply of hot air. The top surface or other controller and/or modifier cause air flow about and across the bottom and at least portions of the sides of the food holder 300 with help from the heat enclosure collar formed by the intermediate section 200. This configuration provides more efficient use of the heat provided by the burner or heat source than when a pot or pan is merely placed upon the unit. This configuration thus conserves heat and energy. It also provides modified and controlled heat transfer as an effect of the moving or swirling hot air emitted from the heat storage chamber. The increased heat transfer to the food holder is made usable or possible using the invention. For example, a heat source may be set to provide a “medium-high” heat, however the invention prevents scorching or burning of the contents of a pot because there is no direct contact with the heat source and the structure of the invention prevents excess heat developing upon the bottom and lower side surfaces of the food holder 300 and along the inside surfaces of the food holder.

### Preferred Heat Emitters

FIGS. 1 and 5 show that the preferred heat emissive openings 125 are advantageously implemented in the form of an opening that provides heated air movement from the hot air reservoir or capacitor formed within the base interior chamber. The construction shown for the emitters 125 provide for heated air movement about the pot or pan. This is configured in the currently preferred construction as an emitter or emitters which provide both a desired upward and lateral movement of the heated and emitted air from the heat reservoir. Heat is transferred to the food holder using a receiver portion 207 of the intermediate part which receives the lower received part 307 of the food holder 300 that fits within the at least one intermediate portion 200.

As shown, the preferred heat emitters may be implemented as louvers or other surfaces which include at least some surface portions which induce a lateral component of velocity and a vertical component of velocity to the heated air emitted from the heat controller 100 through emissive openings 125.

In the currently preferred version, emission louvers 125 are preferably arranged in a radial orientation to direct emitted heated air in a direction roughly tangential to a radial line passing through the louvers. This helps induce a circular flow on the bottom in a circumferential direction. The food holder heating chamber is defined above the base top wall or other modifier and controller, and within the partially confined volume within intermediate piece or ring 200, and beneath and about the received portion of food holder 307.

The louvers or other heat emitters 125 are advantageously laid out in a substantially radial pattern as best shown in FIG. 5. The emitter louvers 125 have two different parts of the emitter pattern. The first part of the louver pattern or primary louvers 126 have louvers arranged along a radial line such that the louvers extend from near the center of the pattern until the outer portions of the top wall 122. The second or secondary louver pattern 129 have less louvers and in the design shown have only two louvers per radii versus three louvers per radii for the primary louver rows or runs 126.

### Intermediate Section or Collar

### Generally

The intermediate section 200 may be a simple heat enclosure collar or be formed in other alternative configurations to perform one or more of the functions indicated. As shown, the intermediate section is formed as an assembly having a suitably shaped heat enclosure collar and plural clips 500. This intermediate section assembly is beneficial in a number of ways indicated and also is relatively easy to produce.

The intermediate section 200 as currently preferred serves several functions. These will be explained in greater detail in the following subsections along with a description of a preferred construction and variants thereof.

### Heat Transfer

One function of the collar section is to help capture heated air emitted through the emitters 125. Also captured is heat that otherwise is transmitted through the top wall or other heat modifier and controller by conduction or any incidental radiant heating.

The captured hot air is retained about the bottom and any received portions of the pan or other food holder 300. This capture and circulation provides time for the heat to be transferred to the food holder using heat already developed by the heat source.

Another function of the intermediate section or heat enclosure collar 200 is to mate with the base in a complementary relationship which aids in retention of a desired amount of heat released from the heat controller into the intermediate assembly.

### Receiver

Still another function of the intermediate assembly is, in the illustrated preferred embodiment, to receive at least portions of the pot 300 or other food holder. The received portions of the at least one food holder is preferably partially within the intermediate assembly. As shown, the intermediate assembly has a brim or top rim 203 which defines a top opening 204. The top opening allows access to a receptacle opening into which portions of the pot or food holder 300 are received within a receiver 207. Depending upon the size of the pot 300, then the manner in which it is held within the receiver may vary.

In a preferred manner the pot has a received portion 307 which fits into receiver 207.

### Lower Portion of Intermediate Section

The apparatuses according to this invention include not only the base section 100 but also preferably the intermediate or collar section 200. Intermediate section 200 is advantageously provided with a first or lower section 201. As shown, the lower section has been formed as a cylinder having a sidewall 202. Other suitable shapes may be possible.

According to the illustrated embodiment, the intermediate assembly shell may also include a transition section 208 suitably joined to the lower part 201. The transition section is shown as a tapered or frusto-conical part. The transition section 208 is joined to lower part wall 202 at joint 207. A variety of manners of making joint 207 are possible. For example, the joint can be brazed, welded, interference fit, adhered or mechanically rolled to provide suitable joinder. The preferable mode is to stamp the intermediate or collar section from a single piece of metal.

### Engagement of Intermediate Section with Base

The cylindrical and other suitable shapes for the bottom edge 230 are beneficially sized to be received upon and engage with the shoulder land 130 of the heat control unit 100 to provide a primary positioning engagement between the base and intermediate assembly. The step 131 adjacent the shoulder land 130, FIG. 6, helps to prevent lateral displacement of the intermediate section relative to the base 100.

The intermediate assembly has a main body which includes the lower section 201, conversion or transition section 202 and a riser or top brim section 203. In addition, there are clips 500 which are advantageously used for greater facility in positioning the food holder, such as provided for in using the preferred pot or pan 300.

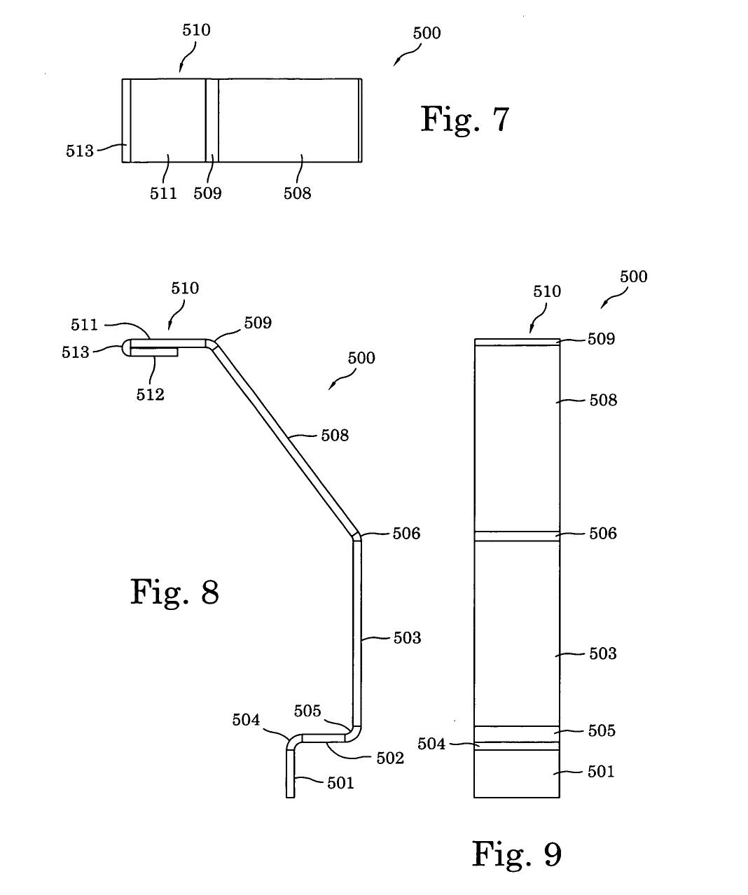

As can be seen in FIG. 1, the heating control 100 top surface may be provided with stabilizer features which enhance the retention of the intermediate section upon the base section 100 in a more secure manner. This secondary engagement is provided in the form of slots or openings 140 which receive or otherwise engage to help prevent relative movement. As shown, slots 140 receive the lower extension sections 501 of the clips 500 illustrated in FIGS. 7-9.

The above aids the primary positioning provided by the complementary shape of the positioning land 130 relative to the bottom rim 230 of the intermediate section.

### Transition Section

The intermediate section or heat enclosure collar 200 also advantageously includes a transition section 202. The transition section represents a change in the size of the collar from a complementary shape relative to the heat modifier and controller formed by the top piece 122, to a shape suitable for supporting a food holder 300 thereon and preferably therein.

As shown, the transition section has an upwardly converging shape, such as the frusto-conical shape shown. The lower edge 207 slopes inwardly to a rim 203. Other configurations are possible.

During operation, the transition section of the heat enclosure collar is used to direct the hot air which is moving within the heat enclosure collar. As shown, the tangential emission of hot air through the emitters cause a circulation across the bottom of the pot and about the received portion in particular. Hot air is discharged in one or more vents formed by having the pot or other food holder smaller in size than the opening formed by rim 203.

### Intermediate Section Top Opening & Rim

The top of the intermediate section is preferably provided with rim 203 which defines the top opening 204. The top opening is preferably larger than the pot 300. Rim 203 preferably extends upwardly in a roughly cylindrical form to provide added strength to resist bending when a pot falls or engages the rim.

### Pot Positioners

Apparatus 100 also preferably include positioners which facilitate the lateral or vertical, or both vertical and lateral position of the pot 300. As shown, the positioners include lateral positioners which are provided in the form of a plurality of clips 500. Vertical positioning is advantageously provided by standoff pegs 150 (see FIG. 6) that act as support spacers for a pot positioned thereon.

### Clips for Positioners and Engagement

Clips 500 have an extension part 501 indicated above for use in engaging the base and intermediate sections. Although it is desirable and preferable to include the pot positioning structure and base engagement function into a single set of clips, it is alternatively possible to divide these functions into separate parts or integral features of the intermediate section or heat enclosure collar.

In the case of engagement features, this may also be formed by extensions from the base in lieu of the base receptacles 140, such that the base extends into the intermediate part 200 (not illustrated).

Further there is a corner 504 connecting to a support section 502 which rests on the top wall of the heat controller. The corner 505 connects to the vertical section 503 which extends along the lower section of the intermediate assembly.

The corner 506 connects to the angled upper section 508 which is complementary to the transition section 508 adjacent the transition section 202 of the intermediate assembly collar shell.

The corner 509 is between angled upper section 508 to inward distal extension 510. The inward distal extension is provided as shown with a top flange 511, inner bend 513, and a lower flange 512. Inner bend 513 acts as a lateral positioner contact.

The positioners 513 are primarily intended to position the pot in lateral relationship so that approximately even annular spacing exists about the side wall of the pot 303 and the top rim 203 of the intermediate section. The annular vent space may vary depending upon the construction and materials of the pot and intermediate section, the size of each, the heat output of the burner, the heat emitted through the base section and other factors. It is alternatively possible to have plural vents by segmenting the annular vent space with positioners or other parts to optimize the amount of hot air vented. It is currently believed preferable that a single annular vent be provided so that heating by the venting air is even about the pot.

### Food Holder or Pot

### Food Holder or Vessel

Food holder 300 has an interior or contents chamber 301 which is for holding food to be warmed or cooked at a relatively moderate heat flux. For example, preparation of sauces, melting of chocolate, keeping sauces warm, cooking or other foods which are often done with low heat flux and at low to moderate temperatures can beneficially be performed using the novel constructions according to the inventions hereof. The invention allows a stove burner or other heat source to provide a “medium-high” heat setting and yet be suitable for holding food to be warmed or cooked at a relatively low to moderate heat including but not limited to sauces, soups, chocolate, caramel and other easily overheated materials.

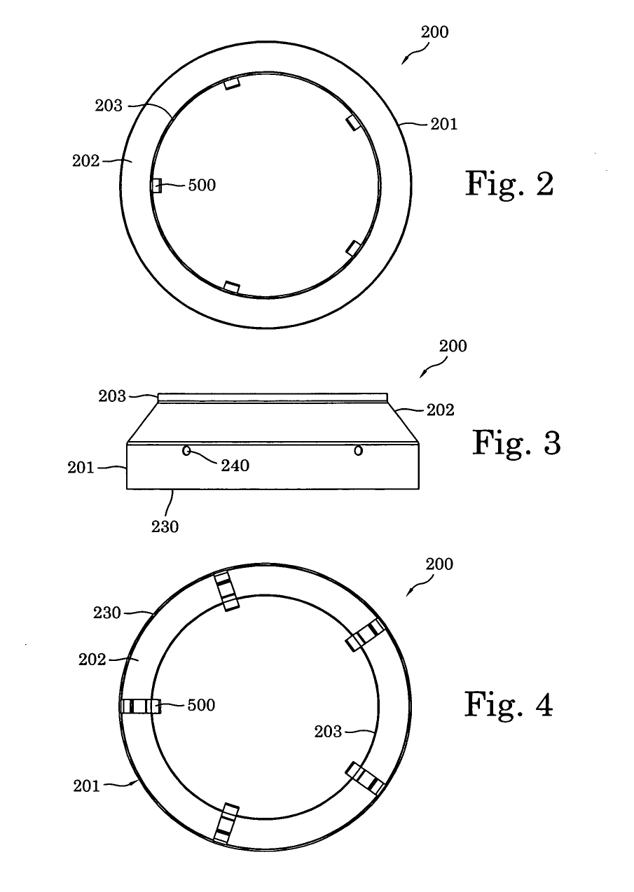

Food holder or vessel 300 is advantageously provided in the form of a pot or pan of suitable size. The suitable size of pot or other food holder may be varied. The various sizes are coordinated to the size of the top opening of the intermediate section and the positioners 500 (FIG. 2). Placement of the food holder into the intermediate section causes a received section 307 at the lower portion of the pot sidewall 308 to be received therein.

### Handle

The pot or other food holder 300 may be provided with a convenient handle in preferred versions. FIG. 1 shows a handle 308 with a stem 309 and attachment 311. A heat resistant handle cover 310 is also shown.

### Optional Lid or Cover

Food holder 300 is shown with an optional lid or cover 400 in FIG. 1. Conventional, suitably sized lids can be used in the well-known manner. The lid is preferably provided with a knob 402 attached to the main lid piece 401.

### Top Vent or Vents

When the pot is positioned with respect to the intermediate section top opening, then there is preferably a vent opening which extends about the pot sidewall 303 and within brim 203. In preferred versions the positioners 500 help to keep the spacing uniform about the pot so that an annular vent opening is created. This helps to direct the hot air venting from within the intermediate section interior to vent upwardly along the sides of the pot providing additional low temperature heat transfer.

In a preferred version the annular space is regularized by the positioner contacts 513 so that heating within pot 300 is more evenly distributed. The spacing typically will vary between one-fourth and three-fourths inches (˜7-21 millimeters) depending upon the size of the unit and the parts thereof, more preferably the space is in the range of approximately one-fourth to one-half inch to retain more heat within the intermediate section interior.

Asymmetrical positioning of the pot in the receiver may alternatively be possible to have a vent shape which, for example, may reduce heat rising by the handle when properly positioned. Thus a non-uniform spacing may be workable if adequate considerations are otherwise made in geometry or other parameters of the apparatus to achieve sufficiently uniform heat flux to the food holder 300.

### Assembly Modes

The apparatus 100 can be assembled in more than one mode. In a first mode the base 100 is joined with the intermediate section to provide a burner modifier which moderates and changes the heat transmission properties between the pan 300 or other food holder and the burner used as the source of heat.

In another assembly the apparatus includes a pan or food holder 300 in combination with such burner modifier formed by the base and intermediate sections when joined. This construction allows the pan to be used in a conventional way with regard to loading contents thereinto, cleaning and other handling.

### Manners and Methods of Use

Methods performed by the novel constructions shown herein include placing a heat collector upon a heat source to provide heated air therein. Methods may further include moderating heat transferred from the heat collector. The moderating may include emitting heated air through a heat modifier adjacent the heat collector heat collection chamber. The emitting may advantageously be done so as to direct the flow in a desired direction. In one form the emitting is done so as to create circulatory action in the flow of the emitted heated air. In another aspect the emitting may be done in a direction tangential to a non-circular shape of the heat modifier.

In a still further aspect methods according hereto may include emitting heated air through louvers. Such produces a reduction or elimination of direct incident radiant heat from the heat source to the area above the heat modifier and the pot or pan being heated.

In a further aspect methods according hereto may include controlling heated air passing from the heated air collection chamber in base 100 to an upper side of the moderator. This controlling may be fixed or variable and will vary as a function of available intake air. In controlling the passing of emitted heated air the air controller desirably helps to provide more uniform temperature of air because the collected heated air is tending to a given temperature depending upon conditions. Then impeding the flow of heated air from the collecting chamber, such as by passing through emitters of less flow area than the surface of the moderator and controller.

Methods hereto may also involve retaining heated air, such as by using a heat enclosure collar and engaging the heat enclosure collar in position above or otherwise appropriately adjacent so that emitted air is passed into the heat enclosure collar. The heat enclosure collar may serve to provide a size change and such may tend to be in size relationship to a food holder so as to allow venting of heated air from the heat enclosure collar about the food holder. The venting is preferably done so as to serve in further providing heat to the food holder.

Methods according to preferred embodiments provides for venting in such a manner so as to provide relatively even heating across the bottom and about the perimeter of the pot or other food holder. This may be accomplished in a variety of ways. One advantageous way is to provide a relatively evenly spaced relationship being the food holder and adjacent parts of the upper heat enclosure collar. In some preferred versions the relatively even spacing is facilitated by positioning using positioners which help to position the food holder. This may be done to provide lateral positioning of the food holder.

Vertical positioning of the food holder relative to the heat enclosure collar and controller and moderator is preferably accomplished by spacing the food holder surfaces so as to not be in contact with the emitters of heated air. Even more preferably, spacing is provided between the upper surfaces of the moderator and controller to prevent contact of the pot bottom upon spacers which serve by spacing and supporting the food holder in a suspended condition over the heat emitters and moderator/controller upper surface to reduce conduction and radiation from such upper surfaces.

Methods according hereto may further be made beneficial so that the heated air within the heat enclosure collar is in a cyclonic or swirling action about the food holder. Such being accomplished by introducing heated air from the heated air capacitor within the base or other containment walls. The introducing of heated air having a lateral velocity and vertical velocity help to provide such swirling of heated air about surfaces of the food holder. This may further be made beneficial by receiving portions of the food holder with the heat enclosure collar and applying heat thereto within the heat enclosure collar. This applying of heat is advantageously done by moving heated air which may in preferred versions be circulating within the heat enclosure collar. Such circulating may be rendered further desirable by inducing a swirling action of heated air coming from the moderator and venting from the upper opening of the heat enclosure collar or other suitable venting.

### Manner of Making

The apparatuses hereto are advantageously made using known metal working and manufacturing techniques used to make pots and pans. However, the inventions according hereto further include forming louvers or other emitters in the top wall of a heat containment assembly or vessel.

### Interpretation Notes

The above description has set out various features, functions, methods and other aspects of the inventions. This has been done with regard to the currently preferred embodiments hereof. Time and further development may change the manner in which the various aspects are implemented. Such aspects may further be added to by the language of the claims which are incorporated by reference hereinto as originally filed.

The scope of protection accorded the inventions as defined by the claims is not intended to be necessarily limited to the specific sizes, shapes, features or other aspects of the currently preferred embodiments shown and described. The claimed inventions may be implemented or embodied in other forms while still being within the concepts shown, described and claimed herein. Also included are equivalents of the inventions which can be made without departing from the scope of concepts properly protected hereby.

### EXAMPLES

### Example 1

### Melting 12 Ounces of Chocolate Chips

Food container placed into apparatus. No lid was used. Heat source set to medium.

| | Temperature | |
|---|---|---|
| Time (minutes) | (Fahrenheit) | Comments |
| 0 | 70 | Pre-heat pan |
| 10 | — | Add chocolate chips. |
| | | Stir when chips shiny on top. |
| | | Continue stirring until |
| | | chocolate is smooth. |
| 20 | — | Turn off heat source. |
| | | Remove pan from base. |
| | | Spooned chocolate from |
| | | pan. Observed no scorching |
| | | or burning of the chocolate. |

### Example 2

### Melting 8 Ounces of Separated Baking Chocolate Bars

Food container placed into apparatus. No lid was used. Heat source set to medium.

| | Temperature | |
|---|---|---|
| Time (minutes) | (Fahrenheit) | Comments |
| 0 | 70 | Pre-heat pan |
| 10 | — | Add baking chocolate |
| | | portions. |
| | | Stir when portions are about |
| | | half melted. |
| 17 | — | Stir when portions are about |
| | | half melted. |
| 20 | — | Chocolate melted. Stir until |
| | | smooth. Turn off heat |
| | | source. Remove pan from |
| | | base. Spooned chocolate |
| | | from pan. Observed no |
| | | scorching or burning of the |
| | | chocolate. |

### Example 3

### Melting 14 Ounces of Caramels

Food container placed into apparatus. No lid was used. Heat source set to medium.

| | Temperature | |
|---|---|---|
| Time (minutes) | (Fahrenheit) | Comments |
| 0 | 70 | Pre-heat pan. Add caramels |
| | | and 2 Tbsp of water. |
| 10 | — | Melting - stir occasionally |
| | | until caramels are |
| | | completely melted. |
| 30 | — | Caramels completely melted. |
| | | Turn off heat source. |
| | | Remove pan from base. |

### Example 4

### Heat 2 Cups of Milk from Refrigerator

Food container placed into apparatus. No lid was used. No stirring. Heat source set to medium-high.

| | Temperature | |
|---|---|---|
| Time (minutes) | (Fahrenheit) | Comments |
| 0 | 40 | Add milk to pan. |
| 17 | 165 | Simmering. Turn off heat |
| | | source. Remove pan from |
| | | base. Observed that the milk |
| | | did not scorch or burn. |

### Example 5

### Cook 5.6 Ounce Package of Lipton® Rice Side—Chicken Flavor

Food container placed into apparatus. Heat source set to medium-high then reduced to medium-low.

| | Temperature | |
|---|---|---|
| Time (minutes) | (Fahrenheit) | Comments |
| 0 | 65 | No lid until after water boils. |
| 18 | — | Water boiling - stir rice into |
| | | water then cover. Reduce |
| | | heat to simmer |
| | | (medium-low). |
| 25 | — | Turn off heat source. Stir rice |
| | | then replace lid. Let stand for |
| | | 1-2 minutes. Stir and serve. |

### Example 6

### Cook 5.6 Ounce Package of Lipton® Pasta Side—Chicken Flavor

Food container placed into apparatus. No lid was used. Heat source set to medium-high.

| | Temperature | |
|---|---|---|
| Time (minutes) | (Fahrenheit) | Comments |
| 0 | 65 | — |
| 22 | — | Water boiling - add and stir |
| | | pasta. Continue boiling and |
| | | stir pasta occasionally until |
| | | pasta is tender. (7-8 min.). |
| 30 | — | Cook according to package |
| | | directions. |

### Example 7

### Cook 8 Ounces of Whole Kernel Corn from Frozen

Food container placed into apparatus. No lid was used. Heat source set to medium-high.

| | Temperature | |
|---|---|---|
| Time (minutes) | (Fahrenheit) | Comments |
| 0 | 10 | Add ¾ cup of water then |
| | | corn. |
| 15 | 125 | Stir occasionally. |
| 27 | 175 | Turn off heat source. |

### Example 8

### Cook 8 Ounces of Whole Kernel Corn from Refrigerated

Food container placed into apparatus. No lid was used. Heat source set to medium-high.

| | Temperature | |
|---|---|---|
| Time (minutes) | (Fahrenheit) | Comments |
| 0 | 40 | Add ¾ cup of water then |
| | | corn. |
| 15 | 175 | Stir occasionally. |
| 26 | 180 | Turn off heat source. |

### Example 9

### Cook 8 Ounces of Green Peas from Frozen

Food container placed into apparatus. No lid was used. Heat source set to medium-high.

| | Temperature | |
|---|---|---|
| Time (minutes) | (Fahrenheit) | Comments |
| 0 | 10 | Add ¾ cup of water then |
| | | peas. |
| 15 | 125 | Stir occasionally. |
| 26 | 175 | Turn off heat source. |

### Example 10

### Cook 8 Ounces of Mixed Vegetables from Frozen

Food container placed into apparatus. No lid was used. Heat source set to medium-high.

| | Temperature | |
|---|---|---|
| Time (minutes) | (Fahrenheit) | Comments |
| 0 | 10 | Add ¾ cup of water then |
| | | mixed vegetables. |
| 15 | 150 | Stir occasionally. |
| 26 | 180 | Turn off heat source. |

### Example 11

### Heat 10.5 Ounces of “Campbells®” Old Fashioned Vegetable Soup

Food container placed into apparatus. No lid was used. Heat source set to medium-high.

| | Temperature | |
|---|---|---|
| Time (minutes) | (Fahrenheit) | Comments |
| 0 | 70 | Add soup and can of water. |
| | | Mix thoroughly. |
| 15 | — | Simmering. |
| 20 | 170 | Turn off heat source then |
| | | stir. |

### Example 12

### Heat 10.75 Ounces of “Campbells®” Tomato Soup

Food container placed into apparatus. No lid was used. Heat source set to medium-high.

| | Temperature | |
|---|---|---|
| Time (minutes) | (Fahrenheit) | Comments |
| 0 | 10 | Add soup and can of water. |
| | | Mix thoroughly. |
| 20 | 180 | Simmering. Turn off heat |
| | | source then stir. |

### Example 13

### Heat 15 Ounces of Mixed Vegetables from Room Temperature

Food container placed into apparatus. No lid was used. No stirring. Heat source set to medium-high.

| | Temperature | |
|---|---|---|
| Time (minutes) | (Fahrenheit) | Comments |
| 0 | 70 | Add vegetables. |
| 17 | 175 | Simmering. Turn off heat |
| | | source. |

### Example 14

### Heat 26.5 Ounces of Spaghetti Sauce from Room Temperature

Food container placed into apparatus. Lid was used. Heat source set to medium-high.

| | Temperature | |
|---|---|---|
| Time (minutes) | (Fahrenheit) | Comments |
| 0 | 70 | Add sauce. |
| 25 | 185 | Simmering. Turn off heat |
| | | source. |

### Example 15

### Heat 13 Ounces of Spaghetti Sauce from Refrigerator

Food container placed into apparatus. Lid was used. Heat source set to medium-high.

| | Temperature | |
|---|---|---|
| Time (minutes) | (Fahrenheit) | Comments |
| 0 | 40 | Add sauce. |
| 25 | 180 | Simmering. Turn off heat |
| | | source. |

### Example 16

### Heat 15 Ounces of Thick, Chunky Chili from Room Temperature

Food container placed into apparatus. No lid was used. Heat source set to medium-high.

| | Temperature | |
|---|---|---|
| Time (minutes) | (Fahrenheit) | Comments |
| 0 | 70 | Add chili. |
| 15 | 175 | Simmering. Turn off heat |
| | | source; remove from |
| | | apparatus. |

### Example 17

### Heat 15 Ounces of Beef Stew from Room Temperature and Refrigerator

Food container placed into apparatus. No lid was used. Heat source set to medium-high.

| | Temperature | |
|---|---|---|
| Time (minutes) | (Fahrenheit) | Comments |
| 0 | 70 | Add stew. |
| 18 | 170 | Simmering. Turn off heat |
| | | source; remove from |
| | | apparatus. Same heating time |
| | | for stew at room and |
| | | refrigerator temperature. |

### Example 18

### Cook One Serving of Quaker® Oats

Food container placed into apparatus. No lid was used. Heat source set to medium-high.

| | Temperature | |
|---|---|---|
| Time (minutes) | (Fahrenheit) | Comments |
| 0 | 70 | Add water. |
| 14 | — | Start boiling. Stir in oats. |
| | | Reduce heat to medium. Stir |
| | | occasionally until thickened. |
| 21 | — | Oats thickened. Turn off heat |
| | | source. |

### Example 19

### Cook Two Servings of Malt-O-Meal® w/Maple and Brown Sugar

Food container placed into apparatus. No lid was used. Heat source set to medium-high.

| | Temperature | |
|---|---|---|
| Time (minutes) | (Fahrenheit) | Comments |
| 0 | 70 | Add water and meal. |
| 20 | — | Boiling. Stir constantly until |
| | | thickened. |
| 25 | — | Thickened. Turn off heat |
| | | source. Remove container |
| | | from apparatus. |

### Example 20

### Cook 5 Ounce Package of Jell-O—Cook & Serve® Banana Cream Pudding

Food container placed into apparatus. No lid was used. Heat source set to medium-high.

| | Temperature | |
|---|---|---|
| Time (minutes) | (Fahrenheit) | Comments |
| 0 | 40 | Add 3 cups of milk. |
| — | — | Add pudding mix and stir. |
| | | Bring mix to a boil. Stir often. |
| 25 | — | Turn off heat source. |
| | | Remove food container from |
| | | apparatus. |

### Example 21

### Cook 5 Ounce Package of Jell-O—Cook & Serve® Chocolate Pudding

Food container placed into apparatus. No lid was used. Heat source set to medium-high.

| | Temperature | |
|---|---|---|
| Time (minutes) | (Fahrenheit) | Comments |
| 0 | 40 | Add 3 cups of milk. |
| — | — | Add pudding mix and stir. |
| | | Bring mix to a boil. Stir often. |
| 22 | — | Turn off heat source. |
| | | Remove food container from |
| | | apparatus. |

### Example 22

### Steam Asparagus with One Cup of Water

Food container placed into apparatus. Lid was used. Heat source set to medium-high.

| | Temperature | |
|---|---|---|
| Time (minutes) | (Fahrenheit) | Comments |
| 0 | 60 | Use steamer tray. Add one |
| | | cup water. Place asparagus, |
| | | cut in half, on steamer tray |
| | | and cover. |
| 15 | — | Asparagus not too soft. Turn |
| | | off heat source. |

### Example 23

### Steam Brussel Sprouts with One Cup of Water

Food container placed into apparatus. Lid was used. Heat source set to medium-high.

| | Temperature | |
|---|---|---|
| Time (minutes) | (Fahrenheit) | Comments |
| 0 | 60 | Use steamer tray. Add one |
| | | cup water. Place peeled |
| | | sprouts on steamer tray and |
| | | cover. |
| 20 | — | Turn off heat source. |

### Example 24

### Steam Peeled and Quartered Large Carrots with One Cup of Water

Food container placed into apparatus. Lid was used. Heat source set to medium-high.

| | Temperature | |
|---|---|---|
| Time (minutes) | (Fahrenheit) | Comments |
| 0 | 65 | Add water. Place carrots on |
| | | steam tray and cover. |
| 25 | — | Firm carrots. Turn off heat |
| | | source. |

### Example 25

### Steam Quartered Head of Cabbage with One Cup of Water

Food container placed into apparatus. Lid was used. Heat source set to medium-high.

| | Temperature | |
|---|---|---|
| Time (minutes) | (Fahrenheit) | Comments |
| 0 | 65 | Add water. Unscrew lift rod |
| | | from steamer tray, place a |
| | | cut side of cabbage on |
| | | steam tray, then cover. |
| 25 | — | Turn off heat source. |

### Example 26

### Steam Whole Small White Potatoes, Skin on, with One Cup of Water

Food container placed into apparatus. Lid was used. Heat source set to medium-high.

| | Temperature | |
|---|---|---|
| Time (minutes) | (Fahrenheit) | Comments |
| 0 | 60 | Add water. Place scrubbed |
| | | and eyed potatoes on steam |
| | | tray, then cover. |
| 40 | — | Fork test, potatoes are |
| | | cooked. Turn off heat |
| | | source. |

### Example 27

### Steam Whole Small Red Potatoes, Skin on, with One Cup of Water

Food container placed into apparatus. Lid was used. Heat source set to medium-high.

| | Temperature | |
|---|---|---|
| Time (minutes) | (Fahrenheit) | Comments |
| 0 | 65 | Add water. Placed scrubbed |
| | | and eyed potatoes on steam |
| | | tray, then cover. |
| 40 | — | Fork test, potatoes are |
| | | cooked. Turn off heat |
| | | source. |

### Example 28

### Steam Two Servings of Broccoli from the Refrigerator

Food container placed into apparatus. Lid was used. Heat source set to medium-high.

| Time (minutes) | Temperature | Comments |
|---|---|---|
| 0 | 40 | Add water. Place broccoli on |
| | | steam tray, then cover. |
| 15 | — | Turn off heat source. |

### Example 29

### Steam Mini Corn on the Cob from Freezer

Food container placed into apparatus. Lid was used. Heat source set to medium-high.

| | Temperature | |
|---|---|---|
| Time (minutes) | (Fahrenheit) | Comments |
| 0 | 10 | Add water. Place corn, on its |
| | | side or on an end, upon |
| | | steam tray, then cover. |
| 30 | — | Corn heated through. Turn |
| | | off heat source. |

I claim:

1. An apparatus for heating foodstuffs in a food holder using a heater having a heater surround, comprising:
a base unit which is adapted for placement over the heater for support by the heater surround, said base unit serving to help contain heat provided from the heater within a heat containment chamber formed at least in part when the base unit is installed over the heater upon said heater surround;
at least one heat modifier provided with emitters which discharge heated air from the heat containment chamber toward said food holder when the food holder is placed into an operational position during use of the apparatus;
at least one intermediate section which joins with the base unit to help direct flow of heated air emitted by the heat modifier about a food holder when a food holder is installed into a receiver formed at least in part by the at least one intermediate section;
at least one guide for positioning a food holder in a desired position when placed in the receiver.

2. An apparatus according to claim 1 and further comprising said food holder which is adapted to fit into the receiver.

3. An apparatus according to claim 1 wherein the emitters direct the air in a direction which includes at least some lateral movement.

4. An apparatus according to claim 1 wherein the emitters are louvers.

5. An apparatus according to claim 1 wherein said at least one guide extends inward to laterally position a food holder in the receiver.

6. An apparatus according to claim 1 wherein said at least one guide include spacers for spacing a food holder placed into the receiver spaced above the emitters.

7. An apparatus according to claim 1 wherein said at least one intermediate section joins with the base using an engaging joint which resists displacement.

8. An apparatus according to claim 1 wherein said at least one intermediate section joins with the base using an engaging joint which resists displacement laterally and vertically.

9. An apparatus according to claim 1 and wherein said at least one guide includes joint portions which help engage the at least one intermediate section with the base.

10. An apparatus according to claim 1 and wherein said base includes at least one handle.

11. An apparatus for heating foodstuffs in a removable food holder using a heater on a range, comprising:
a base unit which is adapted for placement over the heater to help contain heat provided from the heater within a heat containment chamber formed at least in part when the base unit is installed over the heater on the range;
at least one intermediate section which detachably joins with the base unit and forms a receiver for a food holder which positions the food holder in a position wherein the food holder receives even heating;
at least one heat modifier positioned between the heater and intermediate section to form a heat separator having a plurality of emitters which discharge heated air from the heat containment chamber toward said intermediate section in a direction moving about a food holder placed therein.

12. An apparatus according to claim 11 and further comprising a food holder that is adapted to fit into the receiver.

13. An apparatus according to claim 11 wherein the emitters direct the air in a direction which includes at least some lateral movement.

14. An apparatus according to claim 11 wherein the emitters are louvers.

15. An apparatus according to claim 11 and further comprising spacers for spacing a food holder placed into the receiver spaced above the emitters.

16. An apparatus according to claim 11 wherein said at least one intermediate section joins with the base using an engaging joint which resists displacement.

17. A method for heating foodstuffs in a food holder, comprising:
surrounding a range heater with a removable base which forms a heat containment base when installed on the range;
providing an intermediate section on said removable base;
positioning a food holder within a receiver of said intermediate section;
emitting heated air from the heat containment chamber into an area surrounding the receiver to heat the food holder.

18. A method according to claim 17 and further comprising venting heated air about the food holder using at least one opening along upper portions of the receiver.

19. A method according to claim 17 and further comprising spacing the food holder in spaced relationship above the heat containment chamber.
